(19) United States
(12) Patent Application Publication
(10) Pub. No.: US 2009/0257651 A1
(43) Pub. Date: Oct. 15, 2009

(54) COMPRESSION/DECOMPRESSION OF DIGITAL IMAGES

(75) Inventors: Gilles Ries, Saint Jean De Moirans (FR); Tan Sun, Shangai (CN)

Correspondence Address: SEED INTELLECTUAL PROPERTY LAW GROUP PLLC, 701 FIFTH AVENUE, SUITE 5400, SEATTLE, WA, 98104-7092, US

(73) Assignee: STMICROELECTRONICS (GRENOBLE) SAS, Grenoble (FR)

(21) Appl. No.: 12/417,546

(22) Filed: Apr. 2, 2009

(30) Foreign Application Priority Data
Apr. 3, 2008 (EP) 08300171.9

(51) Int. Cl. G06K 9/36

(52) U.S. Cl. 382/166

(57) ABSTRACT

A method of compressing at least a part of a digital image comprises the steps of: dividing said digital image into groups of pixels; assigning a first information to each group of pixels wherein said first information indicates at least two reference colors selected for said group of pixels and, for each pixel in said group of pixels, which reference color or combination thereof is selected; assigning a second information to each group of pixels indicating a mode of compression used for said group of pixels; said first information indicating at least a third color for at least one of said groups of pixels.

### BACKGROUND

1. Technical Field

The present disclosure relates to compression and decompression of digitized images, particularly for information relating to color.

2. Description of the Related Art

Compared to other forms of digital information, digitized images may occupy very large amounts of storage capacity. For situations where information for a large number of images must be transferred from one piece of equipment to another, located in a different place, the cost involved could become prohibitive. Therefore, in such situations, techniques for reducing the volume of the information actually stored and transferred are employed.

A solution is to reduce the number of bits used for the representation of color, thus reducing the overall the file size of image data relating to each image, compared to the file size of the initial data. Various methods exist for this.

FIG. 1a represents a general process of compression which consists of dividing the initial image data IID, which is constructed of a number of pixels, each pixel containing information for color in RGB888 format, into samples. It also consists of performing operations on the data in each sample and producing compressed image data CID in RGB565 format. This compressed image data CID may be then stored in a suitable form and transferred to other equipment.

RGB888 indicates that each pixel contains 8 bits for each of red (R), green (G) and blue (B) color components. Similarly, RGB565 indicates that red and blue have 5 bits each and green has 6 bits allocated to it.

FIG. 1b represents a general process of decompression which occurs at some time after the compression process, whereby operations are performed on compressed image data CID to produce final image data FID.

The various methods for compressing a file of digital image data differ in the size and form of the groups of pixels and in the nature of the operations performed on the data therein. One suite of methods is known as S3TC and is described in U.S. Pat. No. 5,956,431.

FIG. 2 represents a process according to S3 Texture Compression (S3TC), whereby image data is compressed by reducing the amount of information representing color and changing the way this information is stored. Initial image data IID is divided into groups 10 of 4×4 pixels for purposes of processing.

Firstly, for each group in turn, a process of color selection 11 defines two reference colors, based on the colors present in the group 10 of pixels being processed. More detail on the selection of the reference colors will be given later. An encoding process 12 is then performed that results in a 64 bit word 13 for the sample of pixels. The 64 bit word 13 contains 32 bits 14 representing the 2 reference colors in RGB565 and 32 bits containing a look-up table 15 of 4×4 cells which uses 2 bits per cell to indicate which of one of 4 possible colors shall be applied to each pixel during decompression.

The four colors are composed of the two reference colors and two interpolated colors which will be generated from the reference colors, according to predefined relationships, during decompression.

In the example of the well known S3TC technique, as discussed in U.S. Pat. No. 5,956,431, the reference colors are chosen by a mathematical process which calculates averages for the numerical values of the color components for the group as a whole and then establishes a ‘centercenter of gravity’ from these. A line of numerical values passing through this center centerof gravity is then chosen so that the ‘moment of inertia’ (a mean square of the differences between actual values and values on the line) is a minimum. The reference colors are then chosen from colors along this line so as to minimize the errors between original color values on one hand and the reference and resultant interpolated colors on the other.

S3TC contains a number of variants, where the amount and type of information stored for the reference colors is varied. The first variant, which has two modes, will be discussed here.

FIG. 3 represents the relationship of the reference and interpolated colors produced in a first mode. Two reference colors, C0 and C1, are selected as above. Reference colors C0 and C1 form the extremities of a line in color space. During decompression, two interpolated colors, C2 and C3, are generated during decompression where:

$$C 2 = \frac{2}{3} C 0 + \frac{1}{3} C 1 , \\ and$$

$$C 3 = \frac{2}{3} C 1 + \frac{1}{3} C 0.$$

Colors C2 and C3 lie on the line between C0 and C1.

In a second mode, only one interpolated color is generated during decompression as:

$$C 2 = \frac{1}{2} C 1 + \frac{1}{2} C 0 ,$$

and C3 is considered to be transparent.

The choice of mode is indicated by the order in which the reference colors are stored in the compressed image data CID. When the first mode is used, C0 is set numerically greater than C1 and decompression is performed on the basis that there should be two reference colors and two interpolated colors. Where C0 is numerically smaller than C1, the second mode has been used and decompression will be performed on that basis.

A group of pixels in the initial image data occupied 16×24 bits in RGB888 whereas the equivalent group in the compressed image data occupies 64 bits. Thus the compression factor is said to be 6:1.

FIG. 4 represents the decompression process whereby the final image data FID is reconstituted in order to enable display. Compressed image data words CID1-CIDn are provided for n groups of pixels. Each word contains sixteen bits each for two reference colors, C0 and C1 and thirty-two bits for a look-up table of color 15 selection per pixel for each of the sixteen pixels.

The two interpolated colors, C2, C3 are derived from the two reference colors by adding the two reference colors values in proportions defined by the mode of compression used. The four colors, C0 to C3, are presented to a selector 20. For each pixel, the look-up table 15 is consulted and one of the four colors, C0-C3, is selected as the final color for the pixel in question. Groups of de-compressed pixels FID1-FIDn are thus produced and assembled into final image data FID for display as an image.

There are other mathematical techniques for the selection of the reference colors and other techniques for the generation of the colors used in the final image data.

In general the technique described above and other existing techniques achieve acceptable results for most groups of pixels for most images, where the range of numerical values for the individual color components and range of the sums of the color components is small i.e. there is a small gradient between two dominant colors.

However in certain cases, they are unable to produce groups sufficiently close to the original and errors are visible in the final image.

When all component values are zero, the resultant color is black and when all component values are at their maxima, white is the result. When the three components are at intermediate but near equal values, the resultant color is grey. ‘Colored’ pixels are those where one component is at a substantially higher value than the other two.

One simple example of such a case occurs where many of the pixels are very close to black and many very close to white but a small number of pixels are colored. The center of gravity will be on a line between black and white i.e. grey. Furthermore, the line of minimum moment of inertia will pass between near black and near white and so the interpolated colors will not contain a significant predominance of one of the color components i.e. they will be close to grey. When the image is decompressed, it will seem as if the minority ‘colored’ pixels have been ‘lost’.

In general, where there are high gradients of numerical value, such as the contours around objects in the image, existing methods of compression may produce artifacts which degrade the final image, for example changing the way the contour appears.

Furthermore, where there are four or more distinct colors present, the averaging process will ‘lose’ information in a way that may degrade unacceptably the final image.

The U.S. Pat. No. 6,285,458 describes a method whereby some parts if an image are compressed retaining two colors and some parts are compressed retaining four colors. The assigning of interpolated colors is not mentioned.

If present in sufficient numbers, depending on the resolution of the displayed image, the degradation of the displayed image by these errors will be unacceptable.

### BRIEF SUMMARY

One embodiment at least partially addresses one or more of the previously described needs.

One embodiment is a computer-readable medium containing a representation of at least part of a compressed digital image produced from a first image divided into groups of pixels containing:
for at least one of said groups of pixels, information for two reference colors and
for at least one of said groups of pixels, information for two reference colors and for at least a third color obtained by selection based on the colors present in the first image.

According to an embodiment, said third color has a variable value based on colors found in the corresponding group of pixels in the first image.

It is also provided a file containing a representation of at least part of a decompressed digital image, divided into groups of pixels, produced from a file containing a compressed digital image, wherein colors are assigned to each pixel in a group of pixels from a palette of colors which is established for that group of pixels according to an information indicating a mode of decompression for each group of pixels in the file containing the compressed digital image.

According to an embodiment, for at least one group of pixels in the file containing the decompressed digital image, said palette of colors comprises at least three colors that are present in the information in the file containing the compressed digital image for the corresponding group of pixels.

According to another embodiment, for at least one group of pixels in the file containing the decompressed digital image, said palette of colors comprises at least eight colors.

According to an embodiment, a first half of said group of pixels contain colors selected from a first half of said palette of colors and a second half of said group of pixels contain colors selected from a second half of said palette of colors.

It is also provided a method of compressing at least a part of a digital image comprising the steps of:
dividing said digital image into groups of pixels;
assigning a first information to each group of pixels wherein said first information indicates at least two reference colors selected for said group of pixels and, for each pixel in said group of pixels, which reference color or combination thereof is selected;
assigning a second information to each group of pixels indicating a mode of compression used for said group of pixels;
said first information indicating at least a third color for at least one of said groups of pixels.

According to an embodiment, the color assigned to each pixel is selected from a palette of four colors, of which a set of three colors of the palette are present in said information in the compressed format and the fourth color of the palette is generated by a combination of two colors of the set of three colors.

According to another embodiment, wherein the color assigned to each pixel is selected from a palette of eight colors, of which two colors are present in said information present in the compressed format and a first set of three of the colors are generated by combinations of a first pair of the three colors present in the information in the compressed format and a second set of three of the colors are generated by combinations of a second pair of the three colors present in the information in the compressed format.

According to an embodiment, a first half of the group of pixels have colors assigned from a first half of the palette and a second half of the group of pixels have colors assigned from a second half of the palette.

It is also provided a method of decompressing at least part of a representation of a digital image in a compressed format, comprising the step of, for each group of pixels, assigning a color to each pixel generated from information for a corresponding group of pixels present in the compressed format wherein for at least one group of pixels, the color assigned to each pixel in the uncompressed format is generated from information in the compressed format which contains at least three colors.

### BRIEF DESCRIPTION OF THE SEVERAL VIEWS OF THE DRAWINGS

FIG. 1 already described represents a simplified process where a digital image is compressed to a compressed format and then decompressed into a final format.

FIG. 2 already described represents a process of compression of a digital image according to known technique.

FIG. 3 already described represents a relationship of colors retained for use in a decompression process according to a known technique.

FIG. 4 already described represents a process of decompression of a digital image according to known technique.

FIG. 5 represents an embodiment of a structure of a data word for part of compressed digital image.

FIG. 6 represents a relationship of colors retained for use in a mode of an embodiment of decompression process.

FIG. 7 represents an embodiment of a process of decompression of a digital image.

FIG. 8 represents a relationship of colors retained for use in another mode of an embodiment of a decompression process.

FIG. 9 represents a look-up table for use in the mode decompression process referred to in FIG. 8.

FIG. 10 represents a process of decompression of a digital image for the mode referred to in FIGS. 8 and 9.

FIG. 11 represents an exemplary method of selection of colors retained for use in a process of decompression.

FIG. 12 represents an embodiment of an electronic equipment.

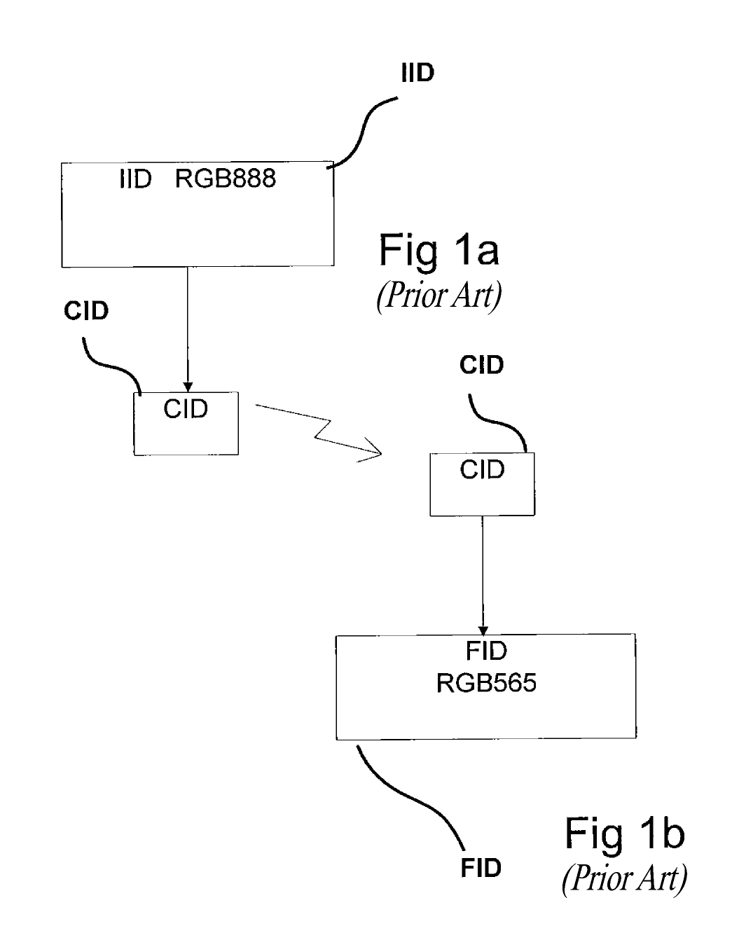

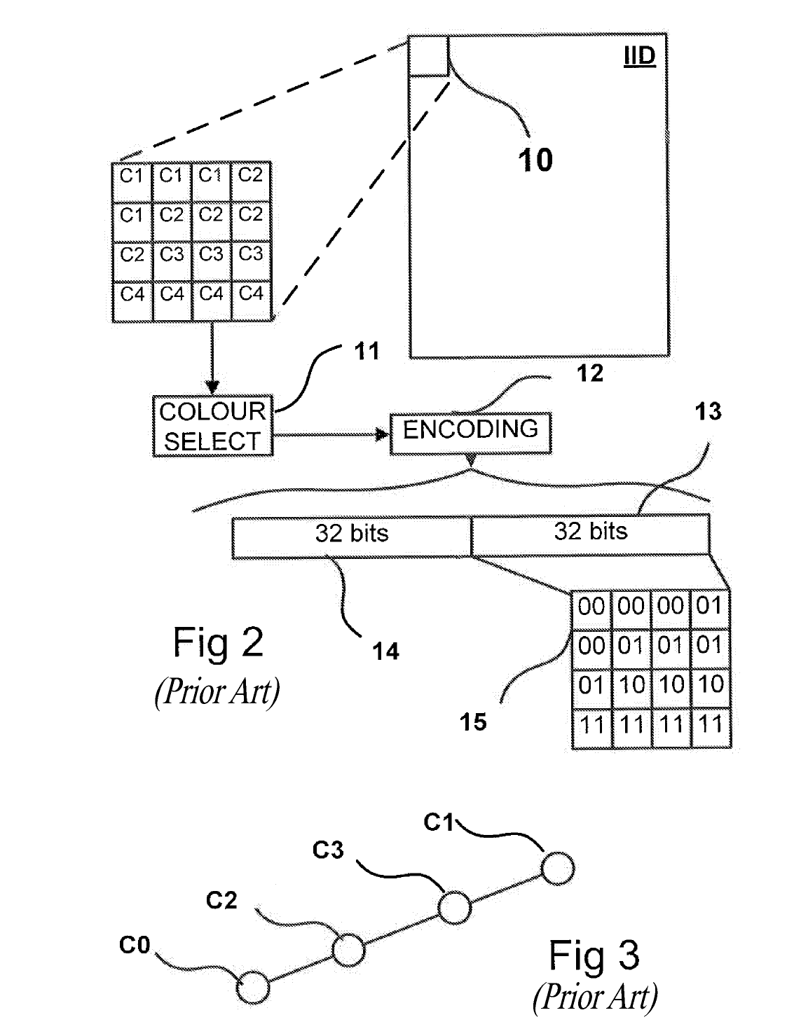

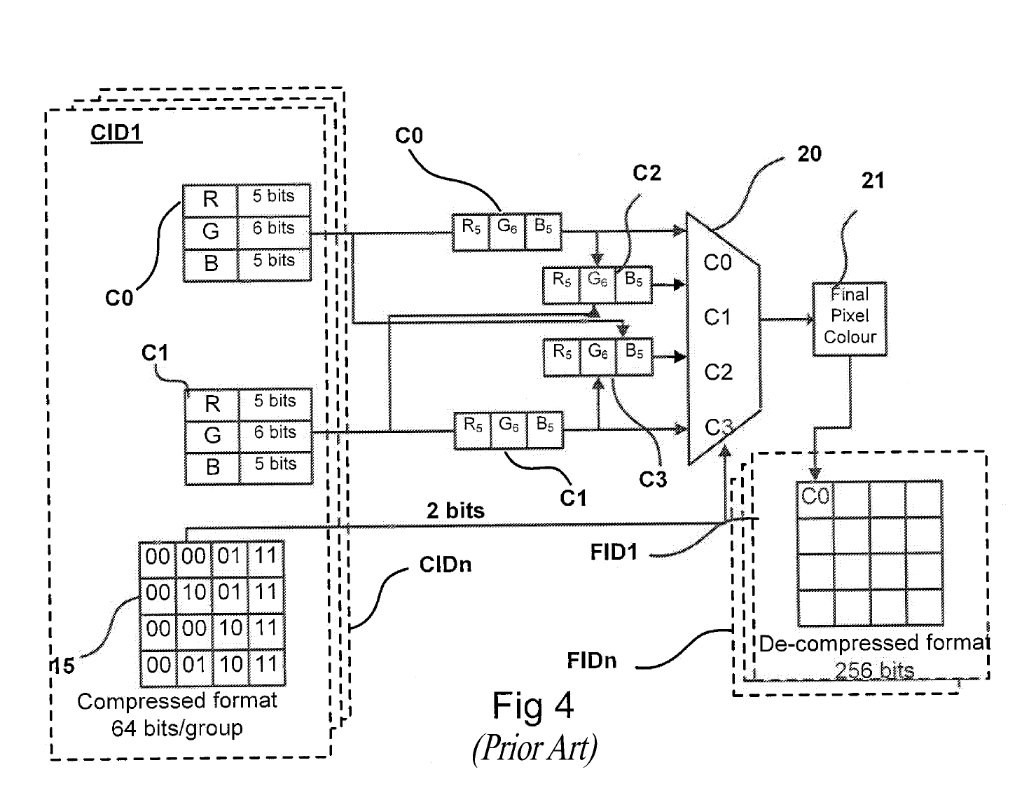

### DETAILED DESCRIPTION

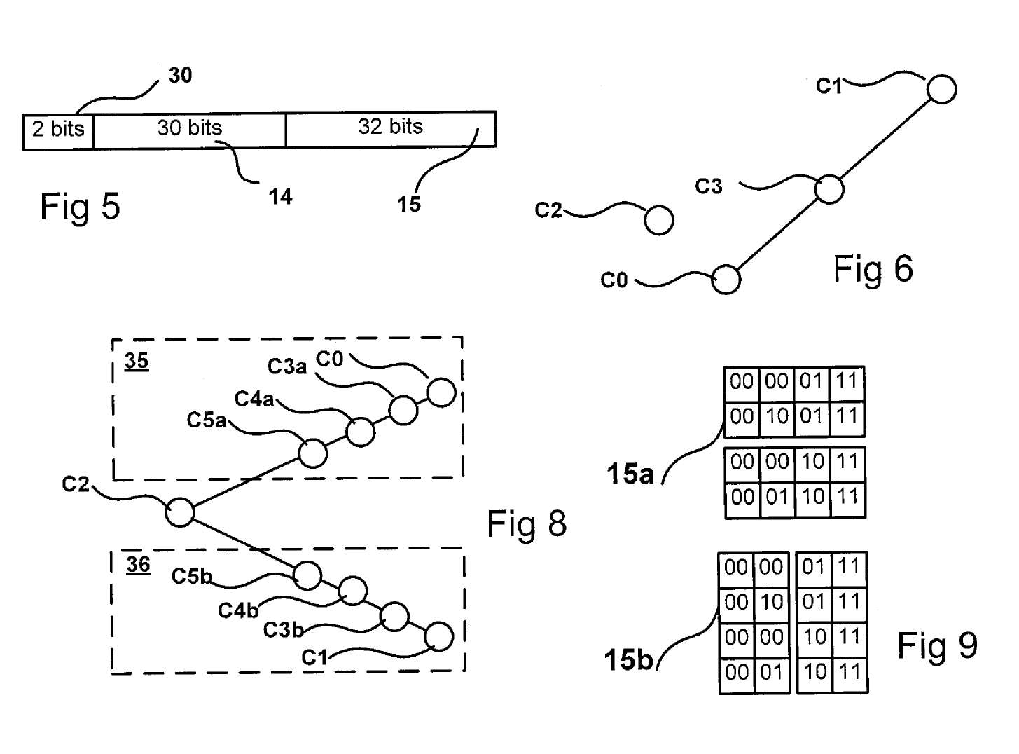

FIG. 5 represents an exemplary structure for the word of data for a group of pixels. A look-up table 15 is composed of thirty-two bits. Thirty bits 14 are reserved for the storage of the color information and are henceforth referred to as ‘reference color bits’ and two bits 30 are used for selecting a mode of compression-decompression.

There is provided a first mode, (henceforth ‘standard mode’) of an embodiment of compression-decompression. Two reference colors, C0 and C1, are stored. However, as compared to S3TC, reference colors C0 and C1 are here stored in RGB555 instead of RGB565. Two interpolated colors, C2 and C3, are derived from these reference colors according to the following relationships:

$$C 2 = \frac{5}{8} C 0 + \frac{3}{8} C 1 , \\ and$$

$$C 3 = \frac{3}{8} C 0 + \frac{5}{8} C 1.$$

FIG. 6 represents the relationship of the reference and interpolated colors for a second mode (henceforth ‘mode 2’) of an embodiment of the compression-decompression. Three reference colors, C0, C1 and C2 are selected and one interpolated color C3 is defined according to the relationship:

$$C 3 = \frac{1}{2} C 1 + \frac{1}{2} C 0.$$

The three reference colors, C0, C1 and C2 are selected by a suitable mathematical method designed to minimize the errors between original and final versions of the group of pixels in question. Reference color C2 may therefore be selected independently of the selection of reference colors C0 and C1 and does not have to have any particular relationship to them.

In contrast to the techniques described previously, one of the colors in the final image is not an interpolated color but a third reference color which is not simply a mixture of the other two reference colors. This allows a color present in a minority of pixels which is significantly far from the line of minimum ‘moment of inertia’ to be preserved.

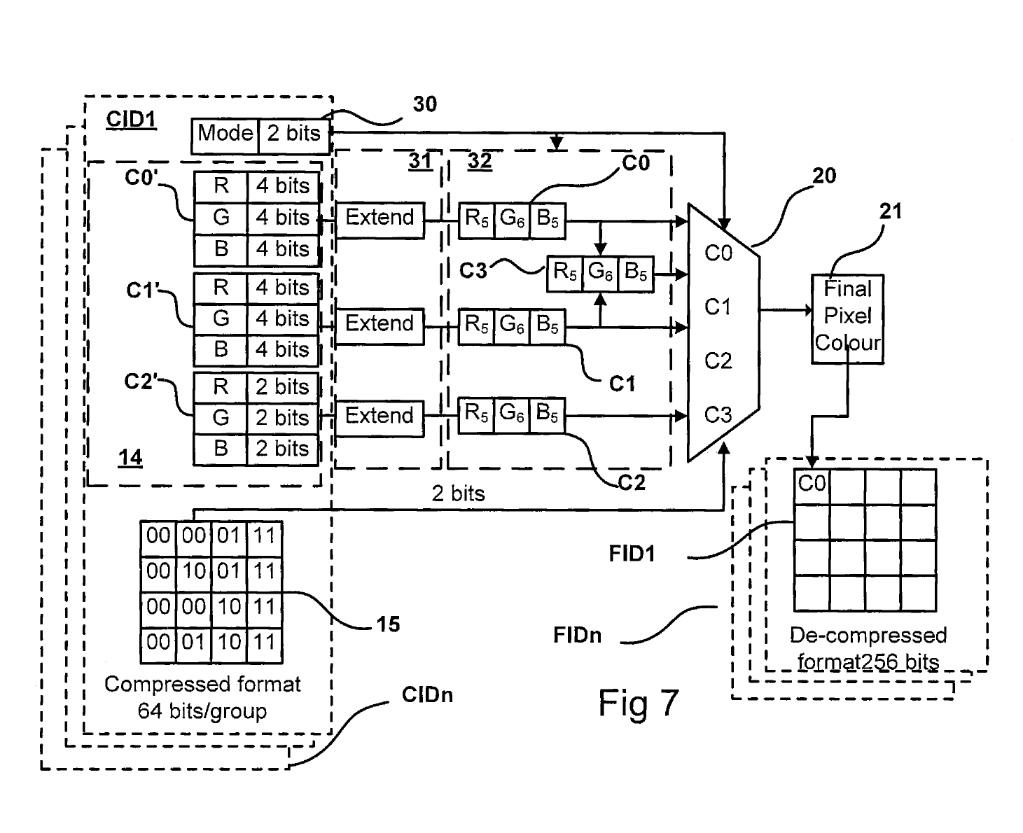

FIG. 7 represents an embodiment of the process of decompression of compressed image data. Firstly two mode selection bits 30 are used to indicate the mode of compression used and hence the mode of decompression required. Reference color bits 14 contain information for three reference colors, C0′ and C1′ in RGB444 format and C2′ in RGB222 format.

The data for C0′, C1′ and C2′ are passed to an extension process 31 which produces reference colors C0, C1 and C2 by converting them to RGB555 format. The mode selection bits 30 are presented to the process of interpolation 32 and the selector 20. The interpolation process 32 generates the interpolated color C3 from reference colors C0 and C1.

The four colors, C0-C3, are presented to a selector 20. For each pixel, the look-up table 15 is consulted and one of the four colors, C0-C3, is selected as the final color 21 for the pixel in question. The groups of decompressed pixels FID1-FIDn are thus produced and assembled into final image data FID for display as an image.

FIG. 8 represents the relationship of the reference and interpolated colors for a further mode, (henceforth ‘mode 3’) of an embodiment of compression-decompression. This mode comprises two submodes.

Three reference colors, C0, C1 and C2 are selected.

A first set of interpolated colors, C3a, C4a and C5a, will be derived from reference colors C0 and C2 according the following relationships:

$$C 3 a = \frac{1}{8} C 2 + \frac{7}{8} C 0 , \\ C 4 a = \frac{2}{8} C 2 + \frac{6}{8} C 0 , \\ and$$

$$C 5 a = \frac{3}{8} C 2 + \frac{5}{8} C 0.$$

And a second set of interpolated colors, C3b, C4b and C5b, will be derived from reference colors C1 and C2 as follows:

$$C 3 b = \frac{1}{8} C 2 + \frac{7}{8} C 1 , \\ C 4 b = \frac{2}{8} C 2 + \frac{6}{8} C 1 , \\ and$$

$$C 5 b = \frac{3}{8} C 2 + \frac{5}{8} C 1.$$

FIG. 9 represents the way that the look-up table is used in the case of this pair of submodes. In a first submode, the look-up table 15a is divided into top and bottom halves, each representing a matrix of 2×4 pixels. The top half has colors assigned from amongst a first set of colors 35 and the bottom half has colors assigned from a second set of colors 36. The interpretation of the look-up table 15a can be summarized as follows:

| | Look-up cell | |
|---|---|---|
| | value | Color applied |
| Top half | 0 | C0 |
| | 1 | C3a |
| | 2 | C4a |
| | 3 | C5a |
| Bottom half | 0 | C1 |
| | 1 | C3b |
| | 2 | C4b |
| | 3 | C5b |

In a second submode, the look-up table 15b is divided into left and right halves, again each representing a matrix of 2×4 pixels and having colors assigned from sets of colors 35 and 36 respectively. The interpretation of the look-up table 15b can be summarized as follows:

| | Look-up cell | |
|---|---|---|
| | value | Color applied |
| left half | 0 | C0 |
| | 1 | C3a |
| | 2 | C4a |
| | 3 | C5a |
| right half | 0 | C1 |
| | 1 | C3b |
| | 2 | C4b |
| | 3 | C5b |

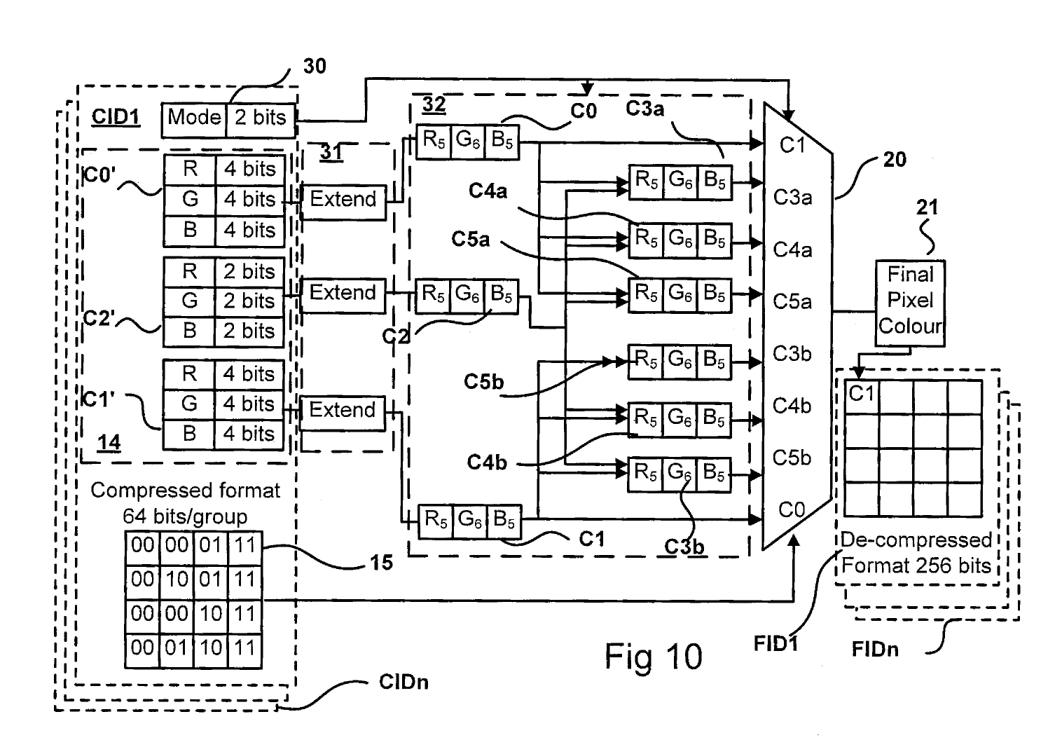

FIG. 10 represents the process of decompression of compressed image data according to the embodiment discussed in relation to FIGS. 8 and 9. Firstly mode selection bits 30 are presented to the interpolation process 32 and the selector 20.

Reference colors bits 14 contain information for three reference colors, C0′ and C1′ in RGB444 format and C2′ in RGB222 format. Thirty-two bits are used as before for a look-up table 15.

The data for C0′, C1′ and C2′ are passed to an extension process 31 which converts them to RGB555 format. The interpolated process 32 derives interpolated colors C3a-C5a from reference colors C0 and C2 and interpolated colors C3b-C5b from reference colors C1 and C2.

The eight colors, C0, C1, C3a-C5a and C3b-C5b, are presented to the selector 20. For each pixel, the look-up table 15 and the mode selection bits 30 are consulted and one of the eight colors is selected as the final color 21 for the pixel in question. The groups of de-compressed pixels FID1-FIDn are thus produced and assembled into final image data FID for display as an image.

In contrast to the modes discussed previously, the third reference color C2 is not actually present in the final image data for a group compressed and decompressed with one of the two submodes of mode 3.

As one skilled in the art will appreciate, this pair of modes may be used advantageously for groups containing more than three significantly different colors.

As will be easily appreciated by one skilled in the art, it is possible to use different modes for different groups of pixels coming from the same file of initial image data. Various methods of implementing this are possible.

A method could be, during the compression process, to decompress a group that has been just compressed and compare the initial image date to the final image data that would result. The errors observed between the initial and final image data could be compared to predetermined criteria in order to choose the mode of compression-decompression to be used for that group.

An advantageous sequence could be to compress the group using the ‘standard’ mode. The group is then decompressed and an evaluation of the errors is performed. If the level of errors is too high, then the mode 2 is tried. If the level of errors is still too high, then one of the submodes of mode 3 is tried. If the level of errors is still too high, then the remaining submode of mode 3 is used.

In all of the above modes, the compression factor for initial image data in RGB888 is 6:1. However, as one of ordinary skill will appreciate, the standard mode retains the greatest precision of color because these are encoded in RGB555 in the compressed format, as opposed to RGB444 or RGB222. Therefore, for groups with low gradients of color and only two dominant colors, this mode will give the greatest fidelity to the original image. Hence it is proposed that this mode be used as standard and tried before modes 2 and 3.

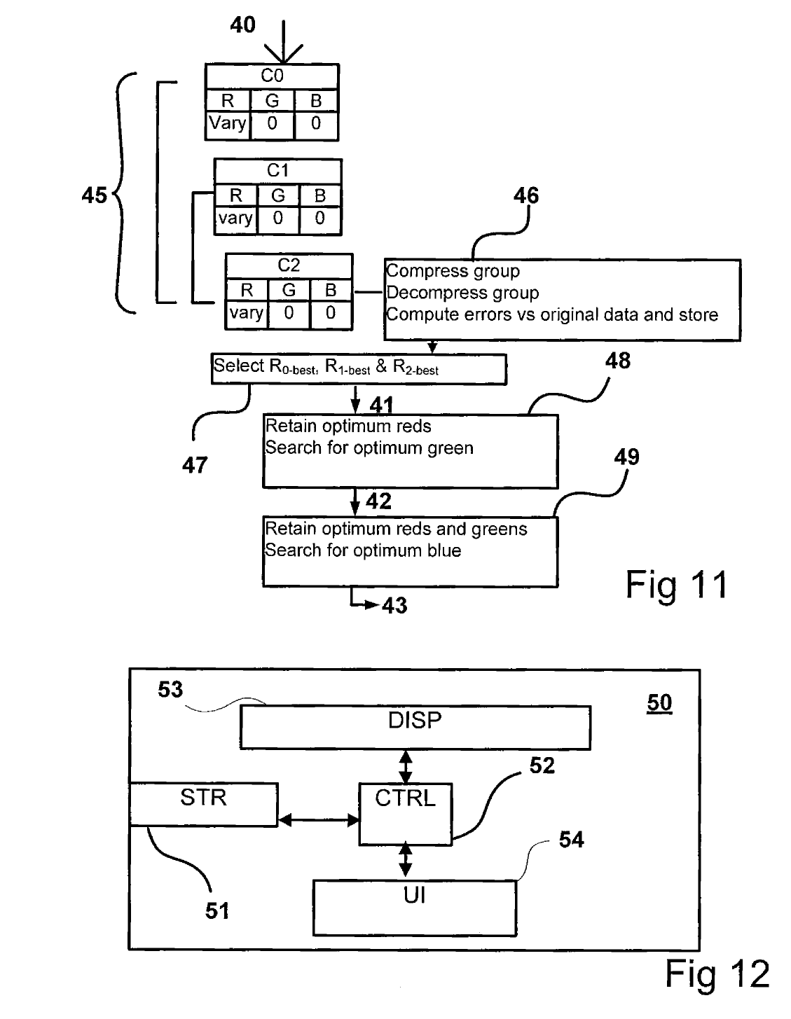

FIG. 11 represents an exemplary process for selecting the reference colors. Optimum values for each of the color components of each reference and interpolated color are searched for individually.

Preferably, the color component presenting the greatest degree of variation of numerical value in the group of pixels in question is identified. Then the color component presenting the smallest degree of variation is identified. For this example, it is assumed that the decreasing order of degree of variation of numerical value is red, green and then blue.

At a starting point 40, the optimum value for the red component of the three reference colors for a group of pixels being processed will be searched for. The values for the green and blue components for the three reference colors, C0-C2, are set to zero.

The values of the red component for each of the three reference colors are varied from 0 to its maximum value in a three level nested loop (bloc 45). In other words, in the example herewith, all of the possible values of the red component for C2 will be tried for each value of the red component for C1 and this process will be repeated for all of the values of the red component for C0. This means that all of the possible combinations of values for the three components will be tried. For each combination of values, the data for a group of pixels of initial image data is compressed (bloc 46) using one of the modes described above, calculating whatever interpolated colors are needed. The same group is then decompressed (bloc 46) and the errors between initial and final image data computed and stored (bloc 46).

This process is repeated until the full range of values for the red components has been tried. The set of three values (R0-best, R1-best, R2-best) that gives the lowest level of errors is then selected (bloc 47) and these are retained as the optimum value for the three reference colors C0, C1 and C2.

The process has now reached point 41.

Retaining the optimum values for the red component for the three colors, C0-C2, the optimum values for the green component for the four colors are sought in a similar manner (bloc 48) and point 42 is reached.

Retaining the optimum values for red and green components for the three colors C0-C2, the optimum values for the blue component are sought for the three colors in turn again in a similar manner (bloc 49) and point 43 is reached.

The overall process is repeated for each group of pixels of the image.

Many search algorithms are available and one of ordinary skill will be able to choose and optimize an algorithm for performing the search for the optimum value of an individual color component.

It is possible to use other mathematical methods for determining the reference colors and one of ordinary skill will be able to make this choice. This choice is a compromise between the processing power of the equipment performing the correction, the amount of data to compress, the time allowed and the quality of the result desired. The use of another mathematical method of determining the reference colors does not impose any particular constraints on the use of any of the modes of compression-decompression provided according to embodiments of the invention.

FIG. 12 represents a mobile equipment 50 incorporating circuitry able to perform decompression of compressed image data according to an embodiment. There is provided a storage medium 51 (STR) which may be a permanent part of the equipment or a removable storage medium. The storage medium 51 could be in the form of memory, either volatile or non-volatile, an optical disk or magnetic storage media. In the storage medium 51 is stored one or more images in the form of compressed image data according to embodiments disclosed herein. A control device 52 (CTRL) is able to decompress the compressed image data according into final image data format for display on a display device 53 (DISP). The user may control the equipment by using a user interface 54 (UI).

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A computer-readable medium containing contents, including a representation of at least part of a compressed digital image produced from a first image divided into groups of pixels, that cause a computing device to implement a method comprising:
decompressing the representation which includes for a first of said groups of pixels, information for two reference colors, and for a second of said groups of pixels, information for said two reference colors and for at least a third reference color obtained by selection based on the colors present in the first image, wherein each reference color includes a different combination of base colors, the decompressing including:
determining a palette of colors based on the first, second, and third reference colors; and
assigning final colors to the pixels in the second group of pixels, respectively, the final color assigned to each pixel being selected from the colors of the palette.

2. A computer-readable medium according to claim 1 wherein said third color has a variable value based on colors found in the corresponding group of pixels in the first image.

3. A computer-readable medium according to claim 1 wherein the palette of colors is established according to information, indicating a mode of decompression for the second group of pixels, in the representation of at least part of the compressed digital image.

4. A computer-readable medium according to claim 3 wherein said palette of colors comprises at least three colors that are present in the representation of at least part of the compressed digital image.

5. The file according to claim 3 wherein said palette of colors comprises at least eight colors.

6. The file according to claim 5 wherein a first half of said second group of pixels contain colors selected from a first half of said palette of colors and a second half of said second group of pixels contain colors selected from a second half of said palette of colors.

7. A method, comprising:
compressing at least a part of a digital image into a compressed image, the compressing including:
dividing said digital image into groups of pixels;
assigning first indications to the groups of pixels, respectively, wherein each first indication indicates at least two reference colors selected for said respective group of pixels;
assigning, for each pixel in said respective group of pixels, from a palette of four colors, which reference color or color combination of the reference colors of the respective group of pixels; and
assigning second indications to the groups of pixels, respectively, each second indication indicating a mode of compression used for said respective group of pixels;
wherein, for at least one of said groups of pixels, said first indication indicates three reference colors, wherein each reference color includes a different combination of base colors, and the fourth color is generated from a combination of two of the reference colors.

8. The method according to claim 7, further comprising decompressing the compressed image, the decompressing including, for each group of pixels:
decompressing the first indication for the group into a palette of colors using the second indication for the group; and
assigning final pixel colors to the pixels of the group, respectively, each final pixel color being selected from the palette of colors for the group.

9. The method according to claim 8, wherein assigning final pixel colors to the pixels of the group, respectively, includes selecting the final pixel colors for the pixels of the group according to a compressed look-up table.

10. A method, comprising:
compressing at least a part of a digital image into a compressed image, the compressing including:
dividing said digital image into groups of pixels;
assigning first indications to the groups of pixels, respectively, wherein each first indication indicates at least two reference colors selected for said respective group of pixels;
assigning, for each pixel in said respective group of pixels, from a palette of eight colors, which reference color or color combination of the reference colors of the respective group of pixels; and
assigning second indications to the groups of pixels, respectively, each second indication indicating a mode of compression used for said respective group of pixels;
wherein, for at least one of said groups of pixels, said first indication indicates three reference colors, wherein each reference color includes a different combination of base colors, and said palette is composed of
two colors that are present in said first indication of the group of which the pixel is a part;
a first set of three colors generated by combinations of a first pair of the three colors present in said first indication of the group of which the pixel is a part; and
a second set of three colors generated by combinations of a second pair of the three colors present in said first indication of the group of which the pixel is a part.

11. The method according to claim 10, wherein a first half of the group of pixels have colors assigned from a first half of the palette and a second half of the group of pixels have colors assigned from a second half of the palette.

12. The method according to claim 10, further comprising decompressing the compressed image, the decompressing including, for each group of pixels:
decompressing the first indication for the group into a palette of colors using the second indication for the group; and
assigning final pixel colors to the pixels of the group, respectively, each final pixel color being selected from the palette of colors for the group.

13. The method according to claim 12, wherein decompressing the first indication of the group includes:
decompressing compressed representations of two reference colors in said first indication of the group;
generating a first set of three colors by combinations of a first pair of the reference colors in said first indication of the group; and
generating a second set of three colors generated by combinations of a second pair of the reference colors in said first indication of the group.

14. A method, comprising:
decompressing a compressed representation of a group of pixels of a digital image, the compressed representation including first, second, and third reference colors, each reference color including a different combination of base colors, the decompressing including:
determining a palette of colors based on the first, second, and third reference colors;
assigning final colors to the pixels in the group of pixels, respectively, the final color assigned to each pixel being selected from the colors of the palette.

15. The method according to claim 14, wherein determining the palette of colors includes decompressing compressed representations of the first, second, and third reference colors of the group and determining a fourth color of the palette based on two of the three reference colors.

16. The method according to claim 14, determining the palette of colors includes:
decompressing compressed representations of the first and second reference colors;
generating a first set of three colors by combinations of a first pair of the reference colors in said first indication of the group; and
generating a second set of three colors generated by combinations of a second pair of the reference colors in said first indication of the group.

17. The method according to claim 14, wherein assigning final colors to the pixels of the group, respectively, includes selecting the final colors for the pixels of the group according to a compressed look-up table.

18. The method according to claim 14, wherein the compressed representation includes an indication of a mode of compression used for compressing group of pixels, wherein determining the palette of colors includes determining the colors of the palette according to the indication of the mode of compression.
